(19) United States
(12) Patent Application Publication
(10) Pub. No.: US 2010/0251453 A1
(43) Pub. Date: Oct. 7, 2010

(54) Garment with Light Signal Indicating System

(76) Inventor: Hsin Yu CHEN, Taipei City (TW)

Correspondence Address: Muncy, Geissler, Olds & Lowe, PLLC, 4000 Legato Road, Suite 310, FAIRFAX, VA, 22033, US

(21) Appl. No.: 12/163,470

(22) Filed: Jun. 27, 2008

(51) Int. Cl. A41D 1/00; G09F 9/33; G08B 21/00

(52) U.S. Cl. 2/69; 340/815.45; 340/669

(57) ABSTRACT

A garment with light signal indicating system is disclosed. The garment comprises a body portion, a plurality of light-emitting assemblies, a battery assembly, a circuit control device and at least one motion sensor, wherein the circuit control device includes a microcontroller and an electric wire which is in electrical communication with the light-emitting assemblies and the battery assembly for conducting power to the light sources from the battery, such that the activation of the light-emitting assemblies can be controlled by an output signal from the motion sensor to the microcontroller when a movement of the motion sensor is detected.

### FIELD OF THE INVENTION

The present invention relates to a garment with light signal indicating system, and more particularly, to a garment capable of immediately showing the intention of a cyclist when riding on road by activating light-emitting assemblies on the garment with motion sensors located on the sleeves and at the back thereof.

### DESCRIPTION OF THE PRIOR ART

Since ecological restoration and eco-awareness like reducing carbon emissions have been enhanced rapidly, greater use of bicycle and other lifestyle changes are proposed and encouraged to reduce carbon emissions that are threatening the environment. In light of this, many people have chosen to commute by foot or on bicycle instead of the use of private vehicles because bike riding is a pollution-free mode of transport that is more energy efficient and less resource consuming than traveling by car, and does not make as much noise as other transport. Besides, bike riding is also one of the most environmentally friendly means of transport and offers great ways to exercise and enjoy nature.

Unlike automobiles and motorcycles which have brake lights and indicators, cyclists do not have the same signaling capabilities when on road. Light indicating signals such as brake, left turn, and right turn are not available to the cyclist. Often times, cyclists have to lift their arms to warn cars and pedestrians of an intention to merge into a different lane of traffic or upcoming turn. However, bike riding may be dangerous that currently cyclists are unable to communicate when they are slowing down or at a stop. Although this may be solved by using lots of lights, but it's still hard to tell what a cyclist is planning to an on-coming vehicle, especially at nights or when the visibility is poor.

In view of this, the inventor provides a garment with light signal indicating system that immediately illuminates light signals in response to the cyclist movement to tell on-coming vehicles what the cyclist intends to do, and the abovementioned problem can thus be solved.

### SUMMARY OF THE INVENTION

The primary object of the present invention is to provide a garment with light signal indicating system, wherein at least one motion sensor and a plurality of light-emitting assemblies are disposed on the garment for immediately actuate the light-emitting assemblies when a movement of the motion sensor is detected so as to display the intention of a cyclist.

It is another object of the present invention to provide a garment with light signal indicating system, wherein a tilt switch and a light-emitting assembly are disposed on each sleeve of the garment for outputting a tilt signal to a microcontroller and actuating the light-emitting assembly of one sleeve when the cyclist lift his arm.

It is still another object of the present invention to provide a garment with light signal indicating system, wherein an accelerometer and a light-emitting assembly is disposed on a back side of the garment for measuring acceleration status of the accelerometer and outputting a corresponding output signal to a microcontroller to change a light signalling pattern of the light-emitting assembly.

In order to achieve the above stated objects, the present invention provides a garment with light signal indicating system, wherein the garment comprises a body portion, a plurality of light-emitting assemblies, a battery assembly, a circuit control device and at least one motion sensor. The circuit control device includes a microcontroller and an electric wire which is in electrical communication with the light-emitting assemblies and the battery assembly for conducting power to the light sources from the battery, such that the activation of the light-emitting assemblies can be controlled by an output signal from the motion sensor to the microcontroller when a movement of the motion sensor is detected.

The present invention will be apparent after reading the detailed description of the preferred embodiments in reference to the accompanying drawings.

### BRIEF DESCRIPTION OF THE DRAWINGS

FIG. 1A is a front perspective view of the garment of the first embodiment according to the present invention;

FIG. 1B is a rear perspective view of the garment shown in FIG. 1A;

FIG. 2A is a rear perspective view of the garment shown in FIG. 1B when the sleeve is not raised;

FIG. 2B is a rear perspective view of the garment shown in FIG. 1B and illustrating that a light-emitting assembly on the sleeve is activated when the sleeve is raised;

FIG. 3A is a rear perspective view of the garment shown in FIG. 1B and illustrating that a light-emitting assembly at the back of the body portion flashs slowly when the cyclist is accelerating;

FIG. 3B is a rear perspective view of the garment shown in FIG. 1B and illustrating that a light-emitting assembly at the back of the body portion flashs quickly when the cyclist is decelerating;

FIG. 3C is a rear perspective view of the garment shown in FIG. 1B and illustrating that a light-emitting assembly at the back of the body portion is completely on when the cyclist is at a complete stop;

FIG. 4A is a perspective view of the garment of another embodiment illustrating the shape of the light-emitting assembly on the sleeve according to the present invention;

FIG. 4B is a perspective view of the garment of another embodiment illustrating the shape of the light-emitting assemblies on the sleeve according to the present invention;

FIG. 5A is a rear perspective view of the garment of another embodiment illustrating the shape of the light-emitting assembly at the back side according to the present invention;

FIG. 5B is a rear perspective view of the garment of another embodiment illustrating the shape of the light-emitting assembly at the back side according to the present invention;

FIG. 5C is a rear perspective view of the garment of another embodiment illustrating the shape of the light-emitting assembly at the back side according to the present invention;

FIG. 5D is a rear perspective view of the garment of another embodiment illustrating the shape of the light-emitting assembly at the back side according to the present invention.

### DETAILED DESCRIPTION OF THE PREFERRED EMBODIMENT

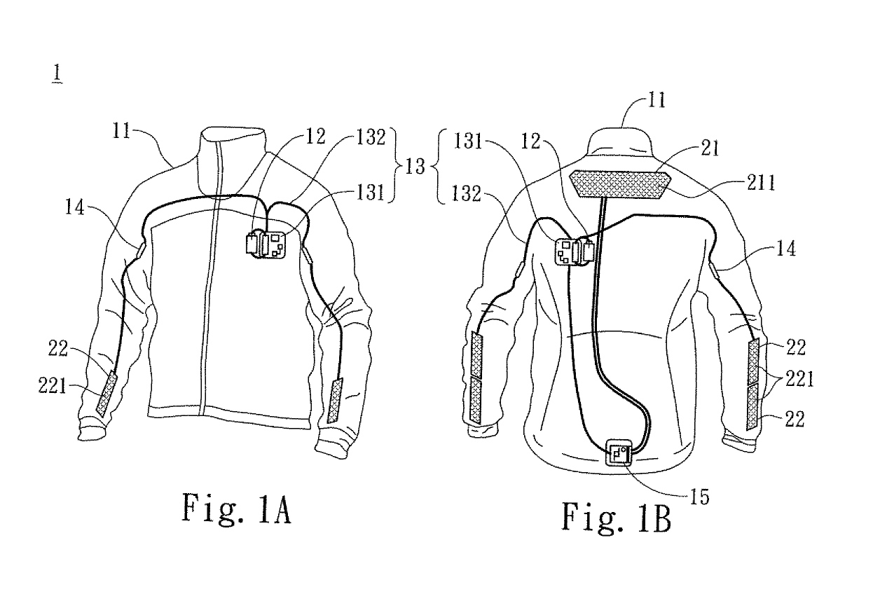

Referring to FIG. 1, showing an embodiment of a garment 1 with light signal indicating system of the present invention, the garment 1 comprises a body portion 11 in the form of a jacket, a plurality of light-emitting assemblies 21, 22 disposed on the body portion 11, a battery assembly 12, a circuit control device 13, two tilt switches 14 and an accelerometer 15 used as motion sensors.

The light-emitting assemblies 21, 22 are located in the elbow and forearm region of each sleeve and at the back of the body portion 11 respectively. Each light-emitting assembly includes a circuit board (not shown) and a plurality of high-brightness light-emitting-diodes 211, 221 mounted thereon, and powered by the battery assembly 12 such as lithium batteries.

The circuit control device 13 is disposed in the body portion 11, and includes a microcontroller 131 and an electric wire 132 which is in electrical communication with the light-emitting assemblies 21, 22 and the battery assembly 12 for conducting power to the light-emitting assemblies 21, 22 from the battery assembly 12. The microcontroller 131 is a PIC microcontroller (Peripheral Interface Controller Microcontroller) and in electrical communication with the tilt switches 14 and the accelerometer 15 for executing programmed instructions to perform operations of the light-emitting assemblies 21, 22 when an output signal from the tilt switches 14 and the accelerometer 15 is received.

The tilt switches 14 are disposed on each sleeve of the body portion 11 for producing a tilt signal when one sleeve is raised over a predetermined angle, and transferring the tilt signal to the PIC microcontroller 131 of the circuit control device 13 to activate the light-emitting assembly 22 on the sleeve. The accelerometer 15 is disposed at a back side of the waist of the body portion 11 for measuring its acceleration status and outputting a corresponding output signal to the PIC microcontroller 131 such that a light signalling pattern of the light-emitting assembly 21 on the back side is determined by the PIC microcontroller 131 upon the output signal for activating the light-emitting assembly 21 at the back side of the body portion 11.

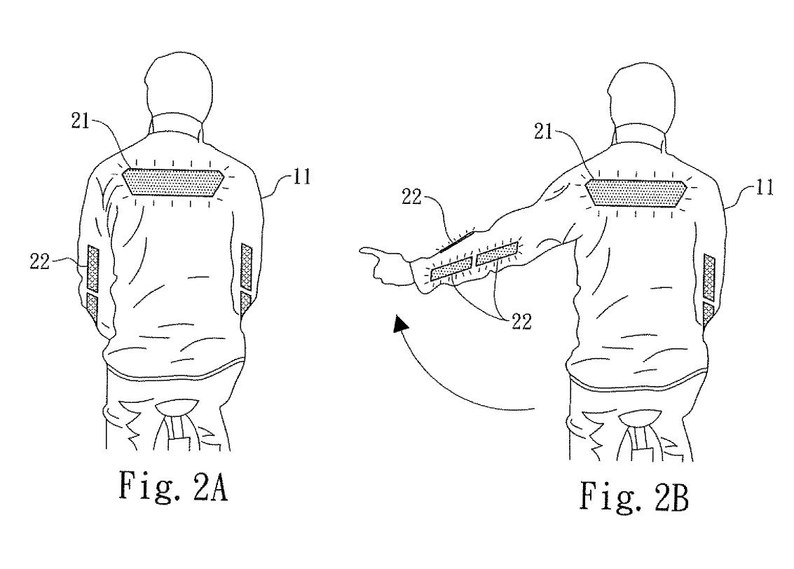

In practice, when worn by a cyclist, the cyclist can simply lift up one arm pass a designated point to actuate a tilt signal from the tilt switch 14 within the sleeve of the body portion 11. The tilt signal is transferred to the PIC microcontroller 131 to activate the light-emitting assembly 22 on the sleeve (as shown in FIGS. 2A and 2B). Once the light-emitting assembly 22 on the sleeve is activated, the light-emitting assembly 22 can be turned off when the sleeve is lowered.

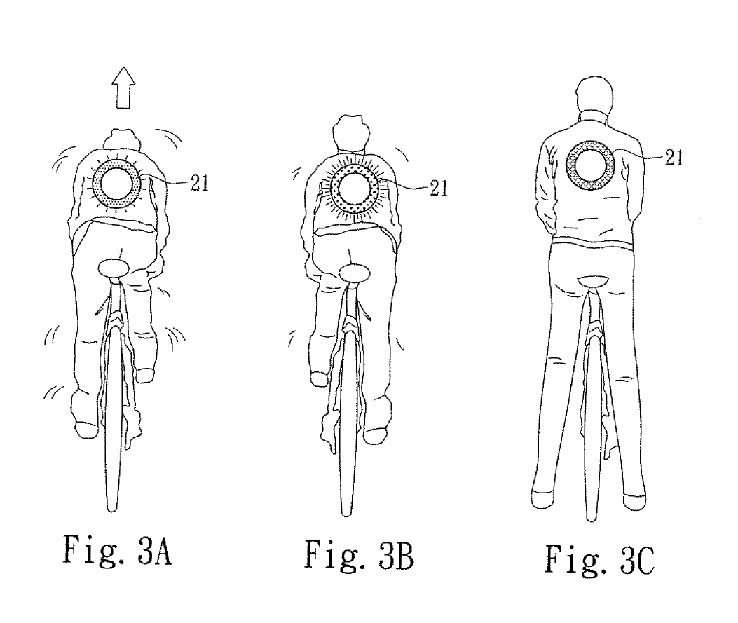

Further, when the cyclist is riding a bicycle, the accelerometer 15 at the back side of the body portion 11 can detect the movement status such as acceleration, deceleration or coming to a stop, and output an corresponding output signal to the PIC microcontroller 131 to determine the light signalling pattern of the light-emitting assembly 21 on the back of the body portion 11. For example, the light-emitting assembly 21 may flash slowly when the cyclist is accelerating or going at a constant speed (as shown in FIG. 3A); the light-emitting assembly 21 may flash quickly when the cyclist is decelerating (as shown in FIG. 3B); and the light-emitting assembly 21 may be completely on when the cyclist is at a complete stop (as shown in FIG. 3C). In this embodiment, the light-emitting assembly 21 at the back of the body portion 11 is used as a rear light for illuminating light signals to on-coming vehicle.

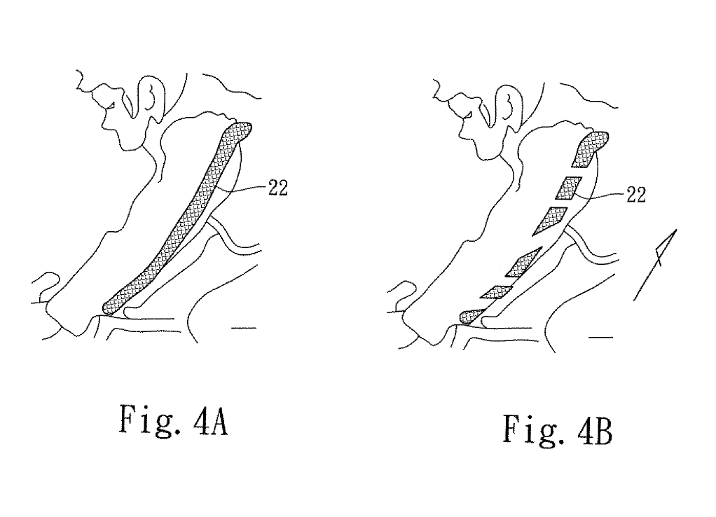

In another embodiment according to the present invention, the light-emitting assembly 22 disposed on each sleeve of the body portion 11 can be designed as a LED light strip (as shown in FIG. 4A) or a plurality of light-emitting assemblies that illuminate sequentially to effectively attained the warning purpose (as shown in FIG. 4A).

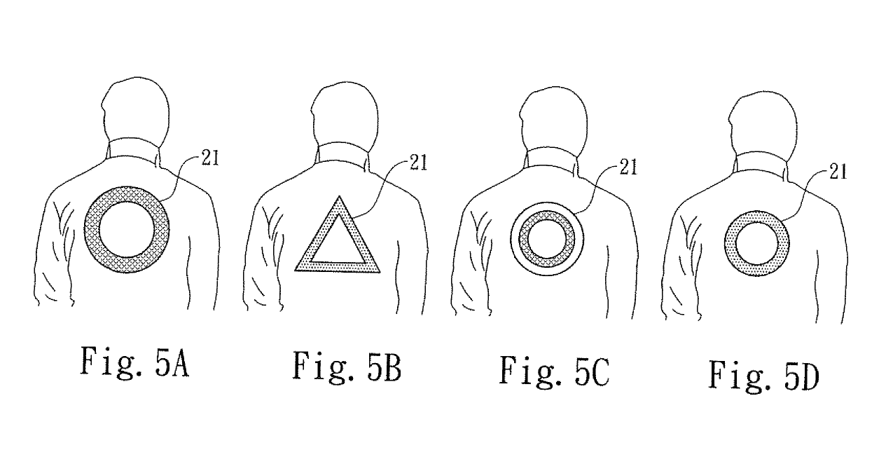

In another embodiment according to the present invention, the light-emitting assembly 21 disposed at the back side of the body portion 11 can be a dot matrix LED display with various conspicuous shapes (as shown in FIGS. 5A-5C), and the dot matrix LED display can be driven by pre-programmed instructions of the PIC microcontroller 131 to change the light signalling pattern, such as changing color in response to the cyclists movements.

In another embodiment according to the present invention, the light-emitting assemblies 21,22 can also be used alongside with EL (electroluminescent lighting) or EL Wire (electroluminescent wire) (not shown).

Therefore, the present invention has the following advantages:

1. The present invention can atone for the shortage of the conventional bicycle which does not have the same signaling capabilities that automobiles and motorcycles have when on road, and immediately indicate the intentions of a cyclist to other road users that enable pedestrians and other road users to see what the bicycle is likely to go in the next few seconds.

2. The present invention can indicate signals such as brake, left turn, and right turn simply by existing movements that are already in the repertoire of biking motions needed to cycle and navigate through urban areas. A cyclist wearing the garment of the present invention can instinctively LED lights in the jacket sleeves whenever he lifts his arm to indicate, and spontaneously change the lighting pattern of the LED assembly on the back of the jacket without learning new methods of operation so as to increase bicycle safety.

3. The present invention has simplified components which can be extensively applied to various garments and thereby increase its practicability.

It should be understood that different modifications and variations could be made from the disclosures of the present invention by the people familiar in the art, which should be deemed without departing the spirit of the present invention.

What is claimed is:

1. A garment with light signal indicating system, the garment comprising:
a body portion;
a plurality of light-emitting assemblies disposed on the body portion for illuminating light signals;
a battery assembly;
a circuit control device disposed in the body portion and including a microcontroller and an electric wire which is in electrical communication with the light-emitting assemblies and the battery assembly for conducting power to the light sources from the battery assembly; and
at least one motion sensor in electrical communication with the microcontroller for outputting an output signal to the microcontroller when a movement of the motion sensor is detected, and thereby control the power output of the microcontroller to activate or turn off the light-emitting assemblies.

2. The garment with light signal indicating system as claimed in claim 1, wherein at least one light-emitting assembly is disposed on a sleeve of the body portion.

3. The garment with light signal indicating system as claimed in claim 2, wherein a motion sensor is disposed in each sleeve of the body portion.

4. The garment with light signal indicating system as claimed in claim 3, wherein the motion sensor is a tilt sensor for outputting a tilt signal to the microcontroller when the sleeve is raised or descended to activate or turn off the light-emitting assembly on the sleeve.

5. The garment with light signal indicating system as claimed in claim 4, wherein the light-emitting assemblies are LED assemblies.

6. The garment with light signal indicating system as claimed in claim 1, wherein at least one light-emitting assembly is disposed on a back side of the body portion.

7. The garment with light signal indicating system as claimed in claim 6, wherein the motion sensor is an accelerometer for measuring its acceleration status and outputting a corresponding output signal to the microcontroller such that a light signalling pattern of the light-emitting assembly on the back side is determined by the microcontroller upon the output signal.

8. The garment with fight signal indicating system as claimed in claim 7, wherein the light-emitting assembly is a LED assembly.
